(19) United States
(12) Patent Application Publication
(10) Pub. No.: US 2011/0250563 A1
(43) Pub. Date: Oct. 13, 2011

(54) INTERDENTAL DEVICE

(76) Inventors: Domonkos Horvath, Jestetten (DE); Sebastian Horvath, Freiburg (DE); Michael Horvath, Jestetten (DE)

(21) Appl. No.: 13/140,344

(22) PCT Filed: Dec. 17, 2009
(86) PCT No.: PCT/EP2009/009086

§ 371 Date: Jun. 16, 2011

(30) Foreign Application Priority Data
Dec. 17, 2008 (DE) 10 2008 062 869.7

(51) Int. Cl. A61C 5/12; A61C 3/00

(52) U.S. Cl. 433/138; 433/149

(57) ABSTRACT

An interdental wedge includes a base body. A cross section of the base body decreases along a length of the base body, at least in places. The base body is three-dimensionally curved, at least in places. An interdental device may include two interdental wedges. One or more interdental wedges may be used for fixing insulating material and/or matrices in the tooth area, and for reversible contact point separation of adjacent teeth, also referred to as separation of the contact points.

The present invention relates to interdental wedges, interdental devices composed of multiple, in particular two, interdental wedges, the use of the interdental wedges and the interdental devices, and methods for fixing insulating material and/or matrices in the tooth area, and methods for reversible contact point separation of adjacent teeth, also referred to as separation of the contact points. The present invention further relates to kits which contain the interdental wedges and/or interdental devices according to the invention. The interdental wedges and the interdental device are particularly suited for dental treatment in humans.

The restoration of hard dental tissue defects using plastic filling materials is a standard treatment method in dentistry. Numerous filling materials are currently available for this purpose. For example, amalgam, glass ionomer cements, ceramic, and composites are used as filling material. The filling materials should be introduced into the cavity with no overflow, or at least with minor overflow. This is particularly important for the cervical half of the crown. However, this area is difficult to access, and the visibility in the interspace is limited. In addition, in this portion of the crown there is a great variety in the shape of cavities. The extremely fine structures present here as well as the anatomy, for example with regard to the marginal gingiva or the papillae, must be taken into account for restoration in the cervical region. On the other hand, a restoration technique free of overflow in the occlusal half of the crown is of lesser importance and is easier to achieve, since this region is readily accessible, and overflows are visible and easily removed. However, in this region the free access for adhesive fastening of ceramic restorations must not be hindered. Open access must be ensured in the equatorial width. In addition, there should be no interference with occlusion control and closing of the mouth.

The matrix technique is used to achieve restoration of a tooth with the least possible overflow. Matrices are shaping aids, and are used to restore the outer shape of the tooth. Matrices are intended to protect the marginal periodontium from overfilled restoration material, the so-called overflow, and to prevent periodontal disease caused by overflows primarily in the cervical region. Various matrix systems are known. For example, ring band matrices, in particular made of metal, primarily according to the Tofflemire system, and partial band matrices, also called partial matrices, are common matrix systems that are frequently used.

The metal ring band matrices were developed in the 1960s. One disadvantage is that the circular tension removes the matrix band from the contact zone of the adjacent tooth. This complicates the contact point design, which is possible only using a contact point instrument. In addition, surmounting the contact point with the metal matrix is difficult. Furthermore, the cervical adaptation of the matrix using an interdental wedge is indispensable, since the matrix system does not contact the tooth tightly enough to prevent overfilling of the filling material.

Interdental wedges represent typical press-on elements for a matrix on the tooth.

Many different types of interdental wedges are known, for example from U.S. Pat. No. 4,578,035, U.S. Pat. No. 4,337,041, or WO 99/09907. These interdental wedges have a linear, oblong base body which tapers in a wedge or converges to a point in the direction of the front end, and have a surface which may have various designs. Wooden wedges are frequently used for fastening matrices. The application of interdental wedges often results in injury to the gums and undesired wide spreading of the teeth. The interdental wedges from the prior art are not able to ensure an anatomical shape of the filling. Controlled filling is not possible, in particular in the region of the contact point of the two teeth which form the interdental space. In addition, the wedges are often extremely difficult to apply.

Partial matrix systems require complicated connecting elements and mounting parts for securely and tightly fixing the partial matrix. On the one hand these are costly to manufacture and purchase, and on the other hand the level of effort for sterilizing these instruments is very high. Furthermore, in these systems the cervical half of the crown is often not tight, resulting in overflows in the cervical interdental region. In addition, for larger cavities the matrix may cave in. Common partial band matrix systems such as Palodent®, Composi-Tight 3D®, or SuperMat® are complex systems, and their fastening elements occupy considerable space in the oral cavity. In addition, many instrument parts are made of metal, which increases the risk of injury. The complex fastening system is so large that it prevents occlusal access for equatorial width ceramic reconstructions. The ring systems used for the fastening prevent or hinder closing of the mouth for occlusion control. Thus, the system is only partially satisfactory for application in ideal cavities. It also requires an extremely large separating force.

A combination of the partial matrix and the interdental wedge is known from DE 3816501 A1. However, such a combination is costly to manufacture as a result of combining and joining various materials having complex structures and shapes.

Dental matrices may possibly not ensure anatomical limiting of the filling space, so that the filling surface may be unsatisfactory. However, subsequent treatment of the filling surface is usually not feasible due to the poor accessibility of the dental interspace.

Thus, the prior art provides no instruments, in particular which are economically manufactured and/or used in a simple and space-saving manner, and which allow absolute tightness, in particular in the cervical zone, which allow a restoration free of overflow.

Systems in which press-on elements, which adapt the matrix, are composed of multiple individual elements result in untight joints in the matrix at the location at which the individual elements meet, i.e., form a transition.

During the dental procedure, the oral region not being treated should be isolated to prevent the patient from aspirating or swallowing small amounts of excess filling material or rinse solutions, for example. In addition, a germ-free work area should be provided, and the tooth area to be treated should be protected from saliva. A rubber dam in particular may be used for the isolation. However, a rubber dam is seldom used for isolation in dental procedures due to the difficulty in applying it, in particular with regard to surmounting the contact zones. In particular, the rubber dam must be fixed, which is usually carried out using rubber dam clamps. However, these take up even more space in the region of the tooth to be treated, and are therefore in the way during the treatment and hinder same. The clamps are also made of metal.

In order to use means and devices from the prior art which ensure a satisfactory restoration that is practically free of overflows, in particular in the cervical half of the crown, and which also meet hygienic requirements, it is necessary to combine the various complex and expensive devices, which are sometimes made of metal, for example the required matrices and the rubber dam as well as two interdental wedges, two ring clamps, and a rubber dam clamp. Such a complex level of effort results in an impediment to the dental procedure, and there are still dangerous overflows in the region of the transition of the wedge to the press-on profile.

The technical object of the present invention is to provide a device which overcomes the deficiencies, in particular the indicated deficiencies, of the prior art.

A further technical object of the present invention is to provide a device which allows satisfactory shaping of the filling in the region of the interdental space.

A further technical object of the present invention is to provide a device which presses at least one matrix against the tooth and adapts same without joints, in particular in the cervical third of the crown and in the dental interspace.

A further technical object of the present invention is to provide a device which allows a tight adaptation of at least one matrix, wherein the device imposes the least possible hindrance, in particular no hindrance at all, for example as the result of its space consumption or its positioning in the vicinity of the site to be treated.

A further technical object of the present invention is to provide a device which separates the contact points in a simple and effective manner.

A further technical object of the present invention is to provide a device which may be easily applied. It is a further technical object of the present invention to provide a device which may be applied with reduced risk of injury.

A further technical object of the present invention is to provide a device which achieves the stated objects and is free of metal.

A further technical object of the present invention is to provide a device which allows a rubber dam to be fixed in the vicinity of the tooth to be treated in a simple and space-saving manner. The aim in particular is to achieve this object in combination with the achievement of at least one of the other objects on which the invention is based. It is a further technical object of the present invention to provide a device which simplifies the mounting of the perforation for the isolation.

A further object of the present invention is to provide a device which achieves a combination of two or more, in particular all, of the stated technical objects.

The object on which the present invention is based is achieved according to the invention by providing interdental wedges according to the patent claims. The object on which the present invention is based is also achieved according to the invention by providing interdental devices according to the patent claims.

The object on which the present invention is based is achieved according to the invention in particular by an interdental wedge comprising a base body, wherein the cross section of the base body decreases along the length of the base body, at least in places, and wherein the base body is curved, at least in places. According to the invention, the cross section of the base body preferably decreases continuously. According to the invention, the cross section of the base body preferably decreases over the entire length of the base body.

According to the invention, the base body is preferably curved in a crescent shape, at least in places. According to the invention, the base body is preferably curved in a crescent shape. Within the context of the present invention, a crescent shape is understood to mean a shape having a concave curvature which tapers in the longitudinal extension.

According to the invention, the base body is preferably curved in at least one plane. According to the invention, the base body is preferably curved in at least one plane, at least in places. According to the invention, the base body is preferably curved in one plane. According to the invention, the base body is preferably curved in one plane in an arc shape, at least in places. According to the invention, the base body is preferably curved in one plane in a crescent shape, at least in places.

According to the invention, the base body is preferably curved in two planes, at least in places. According to the invention, the base body is preferably curved in two planes. According to the invention, the two planes do not extend parallel to one another, and instead have an intersecting edge. According to the invention, the two planes are particularly preferably situated at an angle of 60 degrees to 120 degrees, preferably 85 degrees to 95 degrees, in particular 90 degrees, with respect to one another.

According to the invention, the base body is preferably horizontally as well as vertically curved, at least in places. According to the invention, the base body is preferably horizontally curved, at least in places, and at the same time is vertically curved, at least in places. According to the invention, the first plane, in which the base body is curved at least in places, is therefore preferably the horizontal plane, and according to the invention the second plane, in which the base body is curved at least in places, is preferably the vertical plane.

According to the invention, the base body is preferably three-dimensionally curved, at least in places. According to the invention, the base body is preferably three-dimensionally curved.

Within the context of the present invention, a three-dimensional curvature of the base body is understood to mean a first curvature in the plane that is formed by the x axis and the y axis in the three-dimensional Cartesian coordinate system, and a second curvature in the plane that is formed by the x axis and the z axis, when the length of the uncurved base body is specified as extending along the x axis.

Within the context of the present invention, one skilled in the art is able to understand a three-dimensional curvature of the base body to also mean that the longitudinal axis of the uncurved base body of the dental wedge, which represents the x axis in a Cartesian coordinate system, is curved in the x-y plane as well as in the x-z plane. Within the context of the present invention, unless stated otherwise the term “curvature,” i.e., the change in direction of a curve per unit length, always refers to the curve resulting from the curvature of the straight line which represents the longitudinal axis of the uncurved base body. Within the context of the present invention, therefore, a curvature of a base body is preferably not understood to mean a change in the progression of the contour.

Within the context of the present invention, one skilled in the art is able to understand a curvature of a body to mean that either the entire body or a section of the length thereof has a concave side face or side edge, and has an oppositely situated convex side face or side edge, wherein both side faces or side edges preferably have the same angle of curvature. Therefore, a three-dimensional curvature may be understood to mean that along the longitudinal axis, which represents the x axis in a Cartesian coordinate system, the body has at least one concave side face or side edge in the x-y plane as well as in the x-z plane which in each case is situated opposite from a convex side face or side edge. In one particularly preferred embodiment, the length of the concave side face or side edge, and therefore also of the opposite convex side face or side edge, is the same as the entire length of the body.

According to the invention, the at least one curvature along the length of the base body preferably results in a curvature that ranges from one thirty-second of a full circle to a semicircle.

According to the invention, the cross section of the base body of the interdental wedge preferably decreases along the base body, preferably in at least one longitudinal section of the base body, particularly preferably from one end to the other end.

According to the invention, the cross section of the base body of the interdental wedge preferably decreases continuously along the length of the base body.

Within the context of the present invention, the two ends of an interdental wedge base body are understood to mean the points or faces which have the greatest possible distance from one another, measured along the outer contour of the base body. Within the context of the present invention, the length of the interdental wedge base body is understood to mean the distance between the two ends of the base body, the distance being measured along the outer contour of the base body.

Within the context of the present invention, a cross section refers to the cross-sectional area, i.e., the surface area exposed by a cut through the base body at an angle of 90 degrees with respect to its longitudinal extension.

According to the invention, the base body is preferably three-dimensionally curved in a longitudinal section which occupies more than two-thirds of the length of the base body. According to the invention, the base body is preferably three-dimensionally curved in a longitudinal section which occupies at least 50% of the length of the base body.

According to the invention, the base body is preferably three-dimensionally curved in two longitudinal sections. According to the invention, the base body is preferably three-dimensionally curved in at least two longitudinal sections.

In one alternative embodiment according to the invention, the length of the base body of the interdental wedge may be divided into three sections, namely, into a longitudinal section which adjoins the end of the base body having the largest cross section, i.e., a first outer longitudinal section; a longitudinal section which adjoins the end of the base body having the smallest cross section, in particular the tip of the interdental wedge, i.e., a second outer longitudinal section; and an intermediate longitudinal section, also referred to as the middle longitudinal section, situated between the two outer longitudinal sections. According to the invention, these three longitudinal sections preferably have approximately the same length. According to the invention, these three longitudinal sections preferably have the same length.

According to the invention, the longitudinal section which adjoins the end of the base body having the largest cross section is preferably vertically curved. According to the invention, the longitudinal section which adjoins the end of the base body having the largest cross section is preferably horizontally curved. According to the invention, the longitudinal section which adjoins the end of the base body having the smallest cross section is preferably vertically curved. According to the invention, the longitudinal section which adjoins the end of the base body having the smallest cross section is preferably horizontally curved. According to the invention, the intermediate longitudinal section situated between the two outer longitudinal sections is preferably curved horizontally, not vertically. According to the invention, the intermediate longitudinal section situated between the two outer longitudinal sections is preferably curved vertically, not horizontally. According to the invention, the intermediate longitudinal section situated between the two outer longitudinal sections is preferably curved neither vertically nor horizontally, and in particular is not curved at all. According to the invention, the three-dimensionally curved base body preferably has a middle longitudinal section which is straight, not curved.

In one alternative embodiment according to the invention, the longitudinal section which adjoins the end of the base body having the largest cross section is vertically and/or horizontally curved, the longitudinal section which adjoins the end of the base body having the smallest cross section is vertically and/or horizontally curved, and the intermediate longitudinal section situated between the two outer longitudinal sections is neither vertically nor horizontally curved, and in particular is not curved at all.

In one alternative embodiment according to the invention, the longitudinal section which adjoins the end of the base body having the largest cross section is vertically and horizontally curved, the longitudinal section which adjoins the end of the base body having the smallest cross section is vertically and horizontally curved, and the intermediate longitudinal section situated between the two outer longitudinal sections is neither vertically nor horizontally curved, and in particular is not curved at all.

In one alternative embodiment according to the invention, the longitudinal section which adjoins the end of the base body having the largest cross section is vertically and horizontally curved, the longitudinal section which adjoins the end of the base body having the smallest cross section is vertically and horizontally curved, and the intermediate longitudinal section situated between the two outer longitudinal sections is vertically and horizontally curved, wherein the radii of the curvatures of the three sections are different.

According to the invention, the curvature, in particular the three-dimensional curvature, of the longitudinal section which adjoins the end of the base body having the largest cross section may preferably have the same radius as the curvature, in particular the three-dimensional curvature, of the longitudinal section which adjoins the end of the base body having the smallest cross section.

Within the context of the present invention, “radius of a curvature” is understood to mean the radius which represents the distance from the center point of rotation of the curvature to the correspondingly curved longitudinal section of the base body.

In one alternative embodiment according to the invention, the radii of the two longitudinal sections may also be different. In one preferred embodiment according to the invention, the radius of curvature, in particular the three-dimensional curvature, of the longitudinal section which adjoins the end of the base body having the largest cross section is greater than the radius of curvature, in particular the three-dimensional curvature, of the longitudinal section which adjoins the end of the base body having the smallest cross section.

In another alternative embodiment, the intermediate longitudinal section is vertically and/or horizontally curved. According to the invention, the curvature, in particular the three-dimensional curvature, of the intermediate longitudinal section preferably has a radius that is larger than the radii of the longitudinal sections which adjoin the ends of the base body. In one preferred embodiment according to the invention, the curvature, in particular the three-dimensional curvature, of the intermediate longitudinal section has a radius which is equal to the radii of the longitudinal sections which adjoin the ends of the base body.

In one alternative preferred embodiment according to the invention, the side face or side edge which has a concave design, viewed over the entire length of the base body, has a convex design in the region of the intermediate longitudinal section. This convex design in the intermediate longitudinal section results in a protrusion in this section.

In another alternative embodiment, an insertion aid is associated with the base body at the end having the largest cross section. In another alternative embodiment, the base body has an insertion aid at the end having the largest cross section. The insertion aid may be designed, for example, as an enlargement of the base of the wedge. The insertion aid allows the wedge to be pushed into an interdental space in a simplified and improved manner, since the wedge may be better gripped with the fingers or with instruments such as pincers or a clamp.

The interdental wedge may be adapted to the typical curvatures of a tooth or to the typical curvatures of a certain type of tooth by varying the various radii of curvature of the base body. One skilled in the art is familiar with the shapes and curvatures of a tooth, and is therefore able to select suitable radii of curvature. Radii of curvature between the following ranges are particularly preferred according to the invention:

According to the invention, the radius of curvature is preferably 0.1 mm to 120 mm. According to the invention, the radius of vertical curvature is preferably 0.1 mm to 120 mm. According to the invention, the radius of vertical curvature is preferably 1 mm to 25 mm. According to the invention, the radius of horizontal curvature is preferably 0.1 mm to 120 mm. According to the invention, the radius of horizontal curvature is preferably 0.4 mm to 90 mm.

Of course, the radius of horizontal and/or vertical curvature may vary over the length of the base body, in particular in a range of 0.1 mm to 120 mm. In particular, the three longitudinal sections of the base body mentioned may have different radii in the range of 0.1 mm to 120 mm.

In one alternative embodiment according to the invention, the longitudinal section which adjoins the end of the base body having the largest cross section is vertically and horizontally curved, the radius of curvature being between 2 mm and 15 mm; the longitudinal section which adjoins the end of the base body having the smallest cross section is vertically and horizontally curved, the radius of curvature being between 4 mm and 85 mm; and the intermediate longitudinal section situated between the two outer longitudinal sections is vertically and horizontally curved, the radius of curvature being between 4 mm and 100 mm.

According to the invention, the interdental wedge is preferably curved in such a way that, when it is used in an interdental region, the interdental wedge is concavely curved with respect to one of the teeth forming the interdental region, in particular adapted to the tooth surface, and is convexly curved with respect to the other tooth forming the interdental region, in particular curved convexly and downwardly, and is concavely curved with respect to the gum, thus protecting the gum.

The present invention also achieves the technical object on which it is based in particular by an interdental device having at least two interdental wedges, the base bodies of the interdental wedges being connected to one another at each of their respective ends, in particular essentially in a V-shaped or U-shaped manner.

The present invention also achieves the technical object on which it is based in particular by an interdental device having two interdental wedges, the two base bodies of the interdental wedges being connected to one another at each of their respective ends, in particular essentially in a V-shaped or U-shaped manner.

According to the invention, the base bodies of the interdental wedges are preferably connected to one another at each of their respective ends, in particular essentially in a V-shaped manner.

According to the invention, at least one of the interdental wedges of the interdental device is preferably an interdental wedge, whose design features are disclosed herein. According to the invention, at least one of the two interdental wedges of the interdental device is preferably an interdental wedge according to the invention. According to the invention, both interdental wedges of the interdental device are preferably interdental wedges according to the invention. According to the invention, the two interdental wedges of the interdental device preferably have the same features which are preferred according to the invention. However, the interdental wedges of the interdental device may also have different features in an alternative embodiment.

According to the invention, an interdental device having two interdental wedges according to the invention is preferred, the two base bodies of the interdental wedges being connected to one another at each of their respective ends, essentially in a V-shaped manner.

The interdental wedges and interdental devices according to the present invention may be easily applied. In addition, they do not require special instruments, such as specialized forceps, for the application.

During application, the interdental wedges and interdental devices according to the present invention slide past the papillae and do not injure them. The application may be performed from the back or from the front.

According to the invention, the curvature of the interdental wedges and interdental devices according to the invention, in particular the three-dimensional curvature preferred according to the invention, preferably conforms to the anatomy of the dental crown and the marginal gingiva.

The interdental wedges and interdental devices according to the present invention may advantageously be applied as deeply as possible, i.e., as far as possible in the cervical direction. This simplifies the placement of deep proximal fillings.

The interdental wedges and interdental devices according to the present invention press the matrix firmly against the tooth along the individual contour of the crown. The interdental wedges and interdental devices according to the present invention press and adapt a matrix to the tooth and the margin of the cavity to be filled, without a joint. This is the case in particular in the cervical third of the crown and in the interspace.

The interdental wedges and interdental devices according to the present invention form a press-on element for a matrix or multiple matrices without an interruption in continuity, since they are made of one element and three-dimensionally adapt the contours of the dental crown in the cervical half of the crown, and preferably have a double curvature. In addition, the interdental devices according to the present invention adapt the matrix with a tension that results from spreading the interdental wedges which are joined together.

The interdental wedges and in particular the interdental devices according to the present invention allow pressing and adaptation of either a ring matrix, a partial matrix, or multiple, in particular two, partial matrices. This is also the case for teeth having profound damage.

The interdental wedges and interdental devices according to the present invention allow absolutely tight contact and adaptation in the cervical third of the dental crown without an interruption in continuity of the press-on body. The contact zone for the adjacent tooth is free and unhindered by interfering forces in the middle third of the dental crown. In addition, the occlusal third of the dental crown is open and free for accommodating equatorial width restorations, thus enabling unobstructed visibility.

The interdental wedges and interdental devices according to the present invention represent a biomechanical approach in accordance with the complexity of the marginal, interdental, periodontal, and dental anatomy and ergonomics, and are also coordinated with the adhesive technique.

As the result of wedging wedge bodies in an interdental space, the teeth should be separated from one another by a matrix width of 10 to 50 μm in particular. When the interdental wedge and matrix are removed, the teeth should assume their original position so that they one again contact one another at their contact zones which form a contact point. To achieve this, the wedges must be well wedged in the interdental space. The interdental wedges and interdental devices according to the invention may be wedged particularly well in the interdental space, since they are able to undergo a combined motion composed of translational motion and rotational motion when inserted into the interdental space. Depending on the insertion angle, the translational motion and the rotational motion may be varied, so that, for example, a purely translational motion or a purely rotational motion may be performed when the wedge is inserted. In particular, a rotational motion may be imparted in which the center point of rotation is located in the region of the contact zone of the two teeth, between which the wedge is inserted.

In one alternative embodiment, the interdental wedges and interdental devices according to the present invention may be manufactured as one piece. According to the invention, they may preferably be made of plastic. Economical manufacture is thus possible which allows interdental wedges and interdental devices according to the present invention to be used as disposable instruments. It is thus possible to avoid sterilization costs and reduce the risk of infection.

The interdental wedges and interdental devices according to the present invention press the contact points of two teeth apart in a simple and effective manner. Using only one interdental device according to the present invention, it is even possible to simultaneously separate the mesial and proximal contact points of a tooth from the contact points of the adjacent teeth.

After removal of the interdental wedges and interdental devices according to the present invention, further treatment may be limited to only occlusal grinding and polishing.

The present invention allows the isolating material, for example a rubber dam, to be fixed in a simple and space-saving manner. The present invention allows simple isolation. It is particularly easy to isolate a single tooth. According to the invention, it is preferably not necessary to use metal for the isolation. Isolation of teeth having profound damage is also possible. Multiple interdental devices and interdental wedges according to the invention may also be used for isolating posterior teeth having four contact points. The interdental devices and interdental wedges according to the invention may also be used only for inserting the isolating material, for example a rubber dam, and subsequently removed.

The present invention allows at least one matrix and a rubber dam to be simultaneously fixed, using only one device or only multiple, in particular two, interdental wedges having the same design. The interdental wedges and interdental devices according to the present invention require no further auxiliary fastening means such as ring clamps or rubber dam clamps.

According to the invention, preferred design features of an interdental wedge relate to the interdental wedge itself as well as to at least one interdental wedge as a component of the interdental device. According to the invention, it may preferably be provided that the two interdental wedges of an interdental device according to the invention have different design features which are preferred according to the invention.

According to the invention, the base body of the interdental wedge preferably has a triangular cross section. According to the invention, it may preferably be provided that the cross section is designed as an isosceles, acute, or obtuse triangle. According to the invention, the triangle formed by the cross section of the base body may preferably also have an undercut at least one edge of the triangle, in particular at all edges of the triangle.

In an alternative design, the cross section may have a different shape such as circular, oval, or quadrilateral, in particular square.

The corners of the cross section form the edges of the base body along the length. The corners of the cross section, in particular the triangular cross section, may be rounded or beveled.

According to the invention, the smallest cross section of the base body of the interdental wedge is preferably located at one end of the base body. According to the invention, the largest cross section of the base body of the interdental wedge is preferably located at one end of the base body. According to the invention, the smallest cross section of the base body of the interdental wedge is preferably located at one end of the base body and the largest cross section of the base body is preferably located at the other end.

According to the invention, the smallest cross section of the base body of the interdental wedge is preferably designed as a point or edge, as a rounded point or rounded edge, as a flattened point or flattened edge, or as a surface. According to the invention, the smallest cross section of the base body of the interdental wedge is preferably designed as a point. According to the invention, the smallest cross section of the base body of the interdental wedge is preferably designed as an edge. According to the invention, the smallest cross section of the base body of the interdental wedge is preferably designed as a flattened point. According to the invention, the smallest cross section of the base body of the interdental wedge is preferably designed as a flattened edge. According to the invention, the smallest cross section of the base body of the interdental wedge is preferably designed as a surface, for example in the form of a triangle.

According to the invention, the interdental wedge has a one-piece design.

According to the invention, the interdental wedge is preferably made of a single material. In one alternative, likewise preferred embodiment, the interdental wedge may be made of two materials. Alternatively, the interdental wedge may be made of more than two materials.

In one alternative preferred embodiment according to the invention, the interdental wedge is composed of a core material and a shell material. According to the invention, the core material is preferably harder than the shell material. According to the invention, the shell material is preferably soft. In this embodiment, the hard core material provides sufficient stability, and the soft shell material is able to compensate for fairly high contact pressure and unevenness and provide better wedging.

According to the invention, the interdental wedge is preferably made of a colored material. In one alternative preferred embodiment according to the invention, the interdental wedge is made of a transparent material, in particular a material that transmits UV light. This has the advantage that the interdental wedge allows UV light to pass through for curing a filling, and thus allows better positioning of the UV light source.

In one alternative embodiment according to the invention, at least one of the side edges of the base body has an elastic design. In one alternative embodiment according to the invention, the side edges of the base body have an elastic design. For example, the side edges of the base body may be made of a second material or may be coated with a second material which is more elastic than the material of the base body. According to the invention, the material may preferably be an elastomer. As the result of an elastic design of the side edges, the possibility of injury, in particular to the gum when the interdental wedge is inserted into an interdental space, may be reduced.

In one preferred embodiment according to the invention, the concavely curved side face or side edge is coated with an elastomer. In one preferred embodiment according to the invention, the elastomer layer is thicker in the intermediate longitudinal section of the base body than in the two outer longitudinal sections of the base body. A convex curvature of the concave side face or side edge may thus be achieved over the entire length. Thus, the elastomer may form an elevation or protrusion in the intermediate longitudinal section. This elevation allows better pressing of the matrix, in particular for multirooted teeth, which may have concave outer surfaces in the cervical region.

In one alternative embodiment according to the invention, a matrix which is fastened to a side face, in particular to a concave side face, of the base body is associated with the interdental wedge according to the invention, in particular the three-dimensionally curved interdental wedge. Such a combination of the interdental wedge and the matrix allows direct insertion of the matrix together with the interdental wedge. The matrix thus forms a wing which is laterally mounted on the base body and which seals off the preparation site.

In the prior art, interdental wedges with which a matrix is associated are described in DE 3816501 A1, and are known as Fender Wedges®. For a separate wedge and matrix, it is ideally possible to position the spherically curved matrix at a contact zone and to wedge the interdental wedge with a translational motion without displacing the contact zone region of the matrix, whereas Fender Wedges® do not allow the matrix to be precisely positioned at the contact region, since the wedge and matrix undergo translational motion together.

The alternative embodiment of an interdental wedge according to the invention which is preferred according to the invention, with which a matrix is associated, allows a rotational motion, so that wedging occurs and the contact zone, as a center of rotation, remains in the ideal position. The wedge may thus be inserted in such a way that the matrix is clamped into or contacts the contact zone, so that the contact zone forms the center of rotation when the wedge is inserted. Upon insertion of the wedge according to the invention, which in particular is also vertically curved, insertion may thus take place around the contact zone, thus allowing wedging in which the matrix remains precisely positioned at the contact zone.

According to the invention, the matrix has an anatomical shape. According to the invention, the matrix is preferably made of metal or plastic. According to the invention, the matrix is preferably curved. According to the invention, the matrix preferably follows the curvature of the interdental wedge. According to the invention, the matrix preferably follows the vertical curvature of the interdental wedge. According to the invention, the matrix preferably follows the horizontal curvature of the interdental wedge. According to the invention, the matrix preferably follows the vertical curvature and the horizontal curvature of the interdental wedge. In one alternative preferred embodiment according to the invention, the matrix is not curved.

According to the invention, the matrix preferably has the same length as the base body of the interdental wedge. In one alternative preferred embodiment according to the invention, the matrix is longer than the base body of the interdental wedge, and in particular the matrix projects beyond the end of the base body having the smallest cross section. In one alternative preferred embodiment according to the invention, the matrix is shorter than the base body of the interdental wedge. According to the invention, a shorter matrix is preferably present in the region of the intermediate longitudinal section of the base body.

According to the invention, the matrix may preferably be fastened to the interdental wedge, or the matrix may be a component of the interdental wedge. Thus, according to the invention the interdental wedge and the matrix may preferably have a two-piece or one-piece design.

According to the invention, the matrix may preferably have a protrusion for the contact zone. In an alternative which is likewise preferred, the matrix may have no protrusion, i.e., may be flat in the uncurved state.

In one alternative preferred embodiment according to the invention, a matrix, in particular a matrix which is fastened to a side face, in particular to a concave side face of the base body, is not associated with the interdental wedge, in particular the three-dimensionally curved interdental wedge, according to the invention.

According to the invention, the base body of the interdental wedge is preferably not plastically deformable.

According to the invention, the base body of the interdental wedge is preferably curved at least in places, in particular three-dimensionally curved at least in places, before the interdental wedge is provided and used.

According to the invention, the features of the interdental wedge disclosed in the present patent application, in particular with regard to the curvatures, preferably relate to an interdental wedge according to the invention directly after it is manufactured or before it is used.

According to the invention, the interdental wedge is preferably made of plastic or contains same. According to the invention, the interdental wedge is preferably made of plastic. According to the invention, the plastic is preferably biocompatible. According to the invention, the plastic is preferably nonallergenic or minimally allergenic. According to the invention, the plastic is preferably durable in the mouth.

According to the invention, the plastic is preferably polyethylene. According to the invention, the plastic is preferably polypropylene. According to the invention, the plastic is preferably polyoxymethylene. According to the invention, the plastic is preferably polyethylene terephthalate. According to the invention, the plastic is preferably a polymethylmethacrylate, in particular without additives; the plastic is particularly preferably polyan.

According to the invention, the interdental wedge is particularly preferably made of glass fibers or contains same.

According to the invention, the interdental wedge preferably contains no metal. If desired, the interdental wedge may alternatively be made of metal or contain same.

According to the invention, the interdental device is preferably made of plastic or contains same. According to the invention, the interdental device is preferably made of plastic. According to the invention, the plastic is preferably a plastic named above. However, the interdental device may also be made of another material, in particular a material stated for the interdental wedge, or may contain this material.

The interdental wedges and interdental devices according to the invention may be readily designed by one skilled in the art, using the stated materials, in such a way that their stability and flexibility meet the requirements of use. Thus, the interdental wedges and interdental devices according to the invention, in particular in certain subregions, may be easily provided with necessary flexibility which allows the wedges of the device to be spread apart, the spreading developing tension between the wedges.

According to the invention, the interdental wedges and interdental devices according to the invention may preferably be manufactured using processes such as mass production casting, injection molding, reaction injection molding, or extrusion. The interdental wedges and interdental devices according to the invention may preferably be made of thermosetting or thermoplastic materials. According to the invention, the interdental wedge is preferably manufactured using an injection molding process. According to the invention, the interdental device is preferably manufactured using an injection molding process. According to the invention, the interdental wedge is preferably manufactured using a pressing process. According to the invention, the interdental device is preferably manufactured using a pressing process.

The interdental wedges or interdental devices according to the invention may be provided for disposable or multiple use. According to the invention, the interdental wedge is preferably sterilizable, in particular autoclavable. According to the invention, the interdental device is preferably sterilizable, in particular autoclavable.

According to the invention, the interdental device is designed as one piece.

According to the invention, an interdental device according to the invention is preferred in which the two base bodies of the interdental wedges are connected to one another at the end having the largest cross section.

According to the invention, an interdental device according to the invention is preferred in which the two base bodies of the interdental wedges are not connected to one another at the end having the smallest cross section.

According to the invention, the two base bodies in the interdental device are preferably connected to one another in an elastically deformable manner.

According to the invention, the two base bodies in the interdental device are preferably not connected to one another in a plastically deformable manner.

According to the invention, the two base bodies in the interdental device are preferably curved at least in places, in particular three-dimensionally curved at least in places, before the interdental device is provided and used.

According to the invention, the two base bodies in the interdental device are preferably connected to one another via an intermediate piece. According to the invention, the intermediate piece is preferably elastically deformable.

According to the invention, the two base bodies in the interdental device are preferably situated as legs. According to the invention, the two base bodies in the interdental device are preferably situated as legs, wherein the distance between the legs increases over one section and decreases over another section.

Thus, according to the invention it is preferably provided that the two interdental wedges as legs are oppositely situated in such a way that the two concave faces resulting from the curvature, in particular the three-dimensional curvature, of the base bodies are directly opposite one another.

In one alternative according to the invention, the base body of the one interdental wedge of the interdental device has the same length as the base body of the other interdental wedge. In one alternative according to the invention, the base body of the one interdental wedge of the interdental device is longer than the base body of the other interdental wedge. According to the invention, the base body of the one interdental wedge of the interdental device is preferably up to 5 mm, particularly preferably up to 4 mm, longer than the base body of the other interdental wedge. According to the invention, the base body of the one interdental wedge of the interdental device is preferably 1.5 mm to 4 mm longer than the base body of the other interdental wedge. According to the invention, the length of the base body of one interdental wedge is particularly preferably greater than the length of the other interdental wedge by a factor of 1.01 to 1.18, in particular 1.04 to 1.16, particularly preferably 1.08 to 1.10 (relative to the length of the shorter interdental wedge).

According to the invention, the interdental wedge and the interdental device are preferably dimensioned in such a way that they are adapted to the dimensions in the human mouth, in particular the dimensions of the human tooth and the human interdental dimensions.

According to the invention, the direct distance between the two ends of the interdental wedge base body is preferably 10 mm to 30 mm, in particular 15 mm to 25 mm.

According to the invention, the cross-sectional area of the end having the smallest cross section is 5 to 50 times smaller than the cross-sectional area of the end having the largest cross section.

According to the invention, the two base bodies in the interdental device are preferably connected to one another in such a way that they may be spread by elastically deforming the base bodies and/or the intermediate piece. According to the invention, the two base bodies in the interdental device are preferably connected to one another in such a way that they may be spread by elastically deforming the base bodies and the intermediate piece. According to the invention, the two base bodies in the interdental device are preferably connected to one another in such a way that they may be spread by elastically deforming the intermediate piece.

According to the invention, tension is preferably developed between the base bodies by spreading the base bodies.

A matrix may be pressed tightly against the tooth as a result of the tension during the spreading. The curvature according to the invention of the base bodies allows the matrix to be adapted to the contours of the tooth and thus to lie tightly against same. The tension thus increases the contact pressure on the matrix, which is already developed due to the wedge effect of the base bodies in the interdental region. The interdental wedges of the interdental device thus act on a tooth as a press-on element of a matrix.

According to the invention, the direct distance between the two ends of the base bodies of the interdental wedges of the interdental device, which are not connected to one another, is 1 mm to 5 mm, in particular 1.4 mm to 2.2 mm, in the unspread starting state.

According to the invention, the greatest direct distance between two identical, oppositely situated sections of the base bodies forming the two legs is preferably 4 mm to 12 mm, in particular 6 mm to 10 mm, in the unspread starting state.

According to the invention, the direct distance between the two ends of the base bodies of the interdental wedges of the interdental device, which are not connected to one another, is preferably 8 mm to 25 mm, in particular 11 mm to 19 mm, in the maximum spread state.

According to the invention, the direct distance between the two ends of the base bodies of the interdental wedges of the interdental device, which are not connected to one another, is preferably greater by a factor of 5 to 10 in the maximum spread state than in the unspread starting state.

According to the invention, the maximum angle which may be achieved by spreading apart the two legs of the interdental device is 105 degrees, in particular 98 degrees.

According to the invention, the aperture angle of a leg from the unspread starting position to the maximum spread position is preferably 10 degrees to 45 degrees, particularly preferably 15 degrees to 35 degrees, in particular 18 to 26 degrees.

According to the invention, each of the two legs preferably has an additional section which, in the longitudinal direction of the legs, extends beyond the connecting section of the legs, so that spreading the legs causes the two additional sections to approach one another.

According to the invention, the interdental wedge according to the invention may preferably be adapted to the circumstances for certain types of teeth. According to the invention, the two interdental wedges of the interdental device may preferably be adapted to the circumstances for certain types of teeth. According to the invention, the at least one curvature of the base body may preferably be adapted to a molar. According to the invention, the at least one curvature of the base body may preferably be adapted to a premolar. According to the invention, the at least one curvature of the base body may preferably be adapted to a cuspid. According to the invention, the at least one curvature of the base body may preferably be adapted to an incisor.

According to the invention, therefore, the three-dimensional curvature of the interdental wedge is preferably adapted to the contour of a tooth.

According to the invention, the interdental device according to the invention may preferably be divided into two parts at the intermediate piece by cutting or tearing. According to the invention, the interdental device may therefore preferably be divided into two interdental wedges. This may occur before or after the application in the tooth area. The cutting may be performed using scissors or a scalpel, for example. The tearing may be performed, for example, by twisting the interdental wedges.

According to the invention, the interdental wedge according to the invention preferably has a one-piece design. According to the invention, the interdental device according to the invention preferably has a one-piece design.

According to the invention, the present invention also preferably relates to an interdental wedge, in particular a three-dimensionally curved interdental wedge, comprising a base body having spread leg plates, wherein the base body has an edge which is concavely bent, and wherein a separating film, for example a matrix, for separating the teeth and which projects beyond the edge, is situated in a contact point of the teeth in the region of the edge which is concavely bent.

Such a wedge body has a curvature along its base body. In addition, the legs may be curved, so that a three-dimensional curvature of the interdental wedge is present. In one alternative embodiment according to the invention, the base body itself is three-dimensionally curved.

In this approach, the leg plates are used to delimit the filling space beneath and to the side of the contact point, whereas the separating film delimits the filling space in the region of the contact point. This allows a complete and ergonomically correct delimitation of the filling space at the poorly accessible regions of the tooth. In one preferred embodiment, the base body has a core made of a first material, and a coating made of a second material is applied at least to the leg plates. The first material is selected to be harder than the second material. In such a design, the core of the device is able to impart sufficient stability, and produces the spreading force necessary for pressing the leg plates against the teeth. The coating may adapt to the uneven areas of the tooth surface. In one preferred embodiment, the coating becomes increasingly thinner toward the separating film in order to form a continuous transition, thus preventing undesired steps. According to the invention, the leg plates preferably merge into one another in the region of the edge. According to the invention, an interspace which widens away from the edge is formed between the leg plates. According to the invention, the leg plates may preferably be elastically pressed against one another by decreasing the interspace. According to the invention, the leg plates preferably converge to a point at a first end of the interdental wedge. According to the invention, the leg plates preferably widen toward a second end of the interdental wedge. According to the invention, the base body is preferably wider at the second end, and has a broader taper than at the first end. According to the invention, the separating film is preferably flexible. According to the invention, the radius of curvature of the edge in the region of the separating film is preferably at least 0.5 mm and 3 mm maximum, in particular at least 1 mm and 2 mm maximum. According to the invention, the length of the edge is preferably at least 3 cm. According to the invention, a peelable film is preferably situated on an outer side of the leg plates. According to the invention, the edge is preferably more sharply bent in a middle region than at its ends, and has an essentially U-shaped or V-shaped curve. According to the invention, the separating film preferably follows the edge on one side, and on an opposite side the separating film has an outer edge which extends linearly or convexly. According to the invention, the leg plates are preferably bent in one section, viewed perpendicular to the edge, in such a way that an angle between the leg plates becomes increasingly larger toward the side edges.

Of course, such an interdental wedge which is preferred according to the invention may also have features of the interdental wedge according to the invention described above.

According to the invention, the interdental wedges and interdental devices according to the invention may preferably be used for all types of teeth, for example in the region of the molars, the premolars, or the incisors, i.e., also in the region of the anterior teeth.

The present invention further relates to the use of an interdental wedge according to the invention, in particular to use in dentistry. The present invention further relates to the use of an interdental device according to the invention, in particular to use in dentistry.

According to the invention, an interdental wedge according to the invention is preferably used for fixing at least one matrix in the interdental region. According to the invention, an interdental device according to the invention is preferably used for fixing at least one matrix in the interdental region. The at least one matrix may be a partial matrix or a ring matrix. According to the invention, preferably one or two partial matrices may be fixed.

According to the invention, an interdental wedge according to the invention is preferably used for fixing a rubber dam in the interdental region. According to the invention, the interdental device according to the invention is preferably used for fixing a rubber dam in the interdental region.

According to the invention, an interdental wedge according to the invention is preferably used for pressing apart two adjacent teeth in the contact point region. According to the invention, an interdental device according to the invention is preferably used for pressing apart two adjacent teeth in the contact point region. A missing contact point in a tooth to be treated may be satisfactorily restored by pressing the teeth apart in the contact point region and inserting a matrix.

The present invention further relates to a kit which contains at least one interdental wedge according to the invention according to one of the claims, and operating instructions. The present invention further relates to a kit which contains at least one interdental device according to the invention according to one of the claims, and operating instructions. The present invention further relates to a kit which contains at least one interdental wedge according to the invention according to one of the claims, and at least one matrix. The present invention further relates to a kit which contains at least one interdental device according to the invention according to one of the claims, and at least one matrix. Various shapes of matrices, in particular partial matrices, may optionally be contained in the kit. In particular, matrices, preferably partial matrices, may be contained which are adapted to a curvature of the base bodies of the interdental wedges according to the invention or which are preferred according to the invention. This allows particularly good pressing of the matrix, and thus, particularly good sealing by the matrix.

A kit according to the invention may optionally also contain at least one rubber dam. According to the invention, the interdental wedge according to the invention is preferably sterilely packaged in the kit. According to the invention, the interdental device according to the invention is preferably sterilely packaged in the kit. The present invention further relates to a kit which contains multiple interdental wedges of various sizes. The present invention further relates to kit which contains multiple interdental devices of various sizes. “Various sizes” is understood to mean in particular various lengths and various degrees of curvature of the base bodies, in particular which are adapted to certain types of teeth.

The present invention further relates to a method for fixing at least one matrix to a tooth, in particular in a proximal region or in both proximal regions of the tooth, comprising steps a) placing the at least one matrix on the tooth, in particular in the region of a cavity, and b) inserting the two interdental wedge base bodies of an interdental device according to the invention, wherein the first interdental wedge base body is inserted into the distally adjacent interdental region of the tooth, and the second interdental wedge base body is inserted into the mesially adjacent interdental region of the tooth, so that the at least one matrix is clamped between the tooth and one of the interdental wedge base bodies.

According to the invention, it is provided that the interdental device is spread in step b).

The interdental device may be inserted from the back or from the front, as desired. According to the invention, the interdental device is preferably inserted from the back, since at this location the interdental space forms a wider gap, thus simplifying the insertion and further reducing the risk of injury.

According to the invention, the at least one matrix is preferably a partial matrix. According to the invention, the partial matrix preferably has a three-dimensional shape which is adapted to the three-dimensional curvature of the base body of the interdental wedge which presses the matrix against the tooth.

According to the invention, the tooth is preferably isolated with a rubber dam prior to step a). The rubber dam is then fixed by the interdental device in step b).

According to the invention, a base body, particularly preferably the longer of two base bodies having different lengths, initially is preferably inserted only partially into the interdental region. The interdental device is then spread, and the second, in particular shorter, base body is partially inserted into the other interdental region. Both base bodies may then be inserted up to the desired position.

Further preferred embodiments of the invention are stated in the subclaims.

Preferred exemplary embodiments of the invention are shown in the figures and described in the examples.

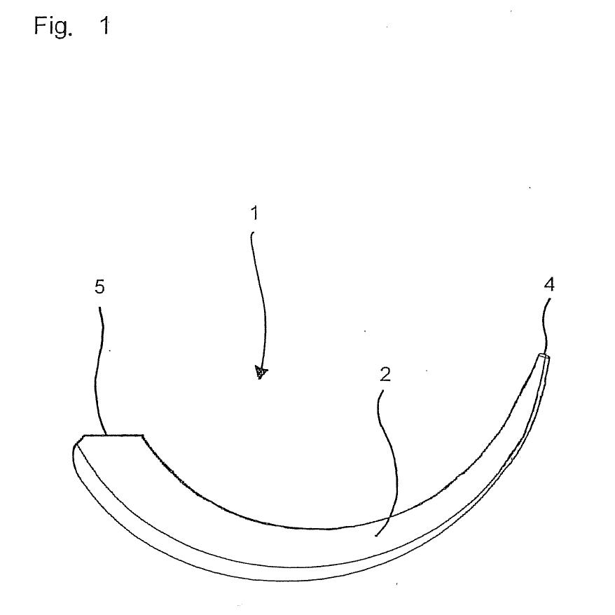

FIG. 1 shows a preferred interdental wedge according to the invention.

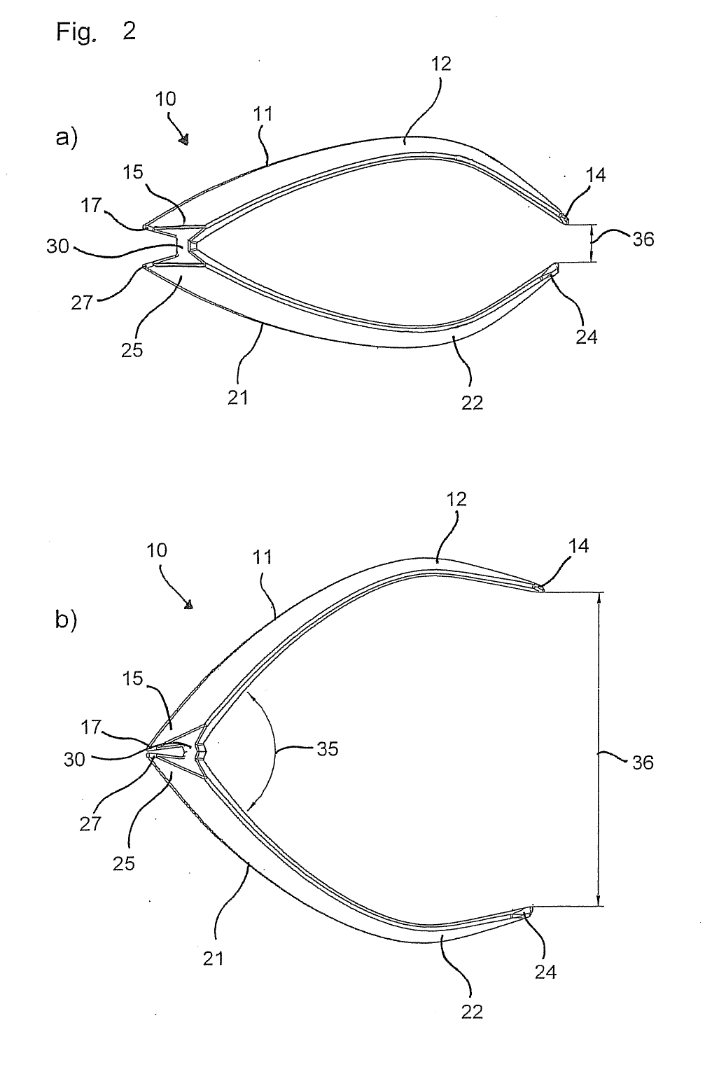

FIG. 2 shows a preferred interdental device according to the invention. In a) the device is shown in the base position, i.e., in the unspread position. In b) the device is shown in the spread position.

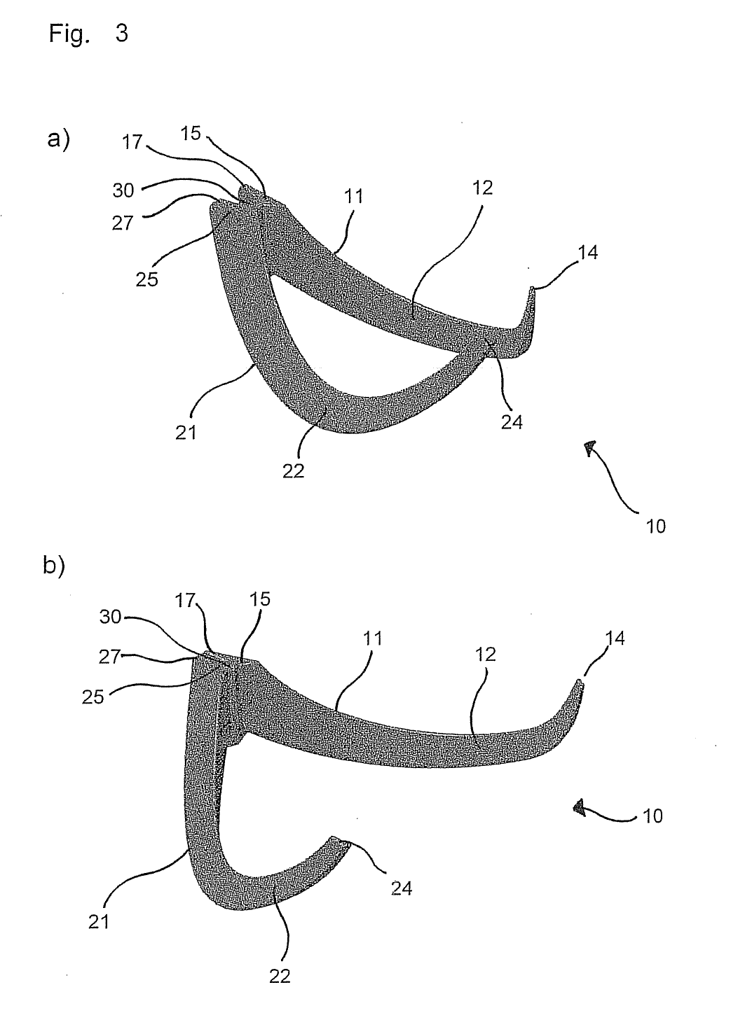

FIG. 3 shows a preferred interdental device according to the invention. In a) the device is shown in the base position, i.e., in the unspread position. In b) the device is shown in the spread position.

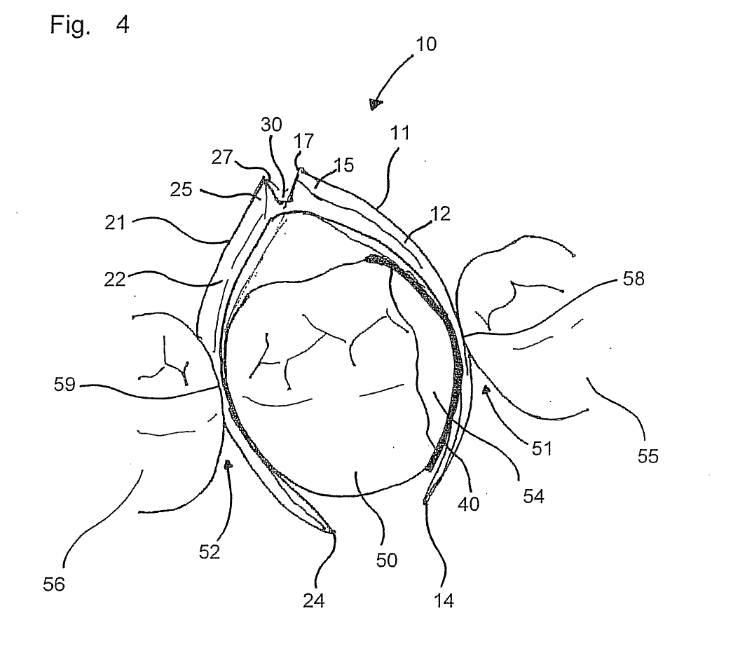

FIG. 4 shows the use of a preferred interdental device according to the invention for fixing a matrix to a tooth.

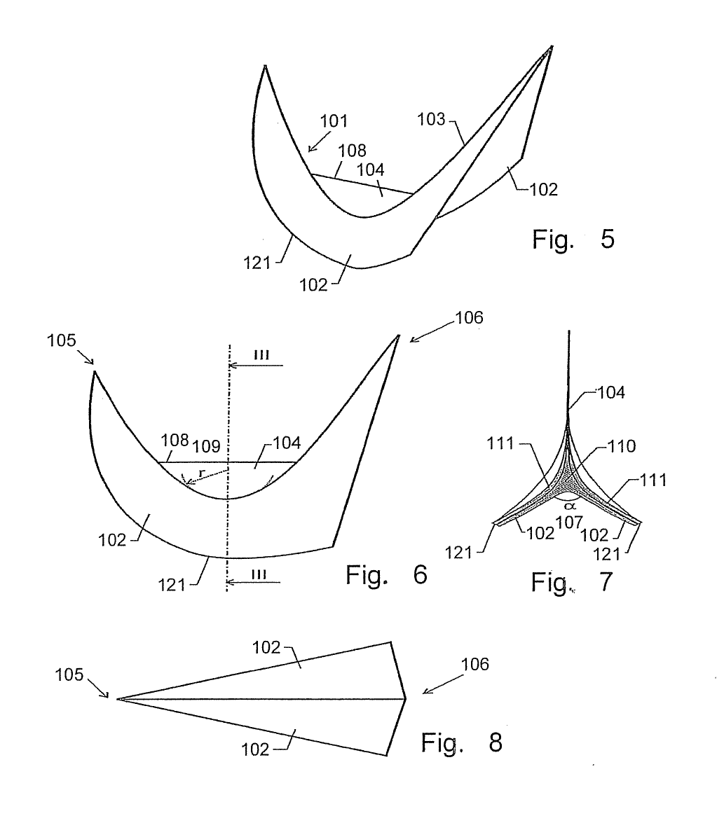

FIG. 5 shows a view of one design of an interdental wedge according to the invention, having a base body with spread leg plates.

FIG. 6 shows a side view of the device according to FIG. 5.

FIG. 7 shows a section along line III-III from FIG. 6.

FIG. 8 shows a top view of the device from FIG. 5.

FIG. 9 shows a view of the interdental wedge according to FIG. 5 after insertion between two teeth.

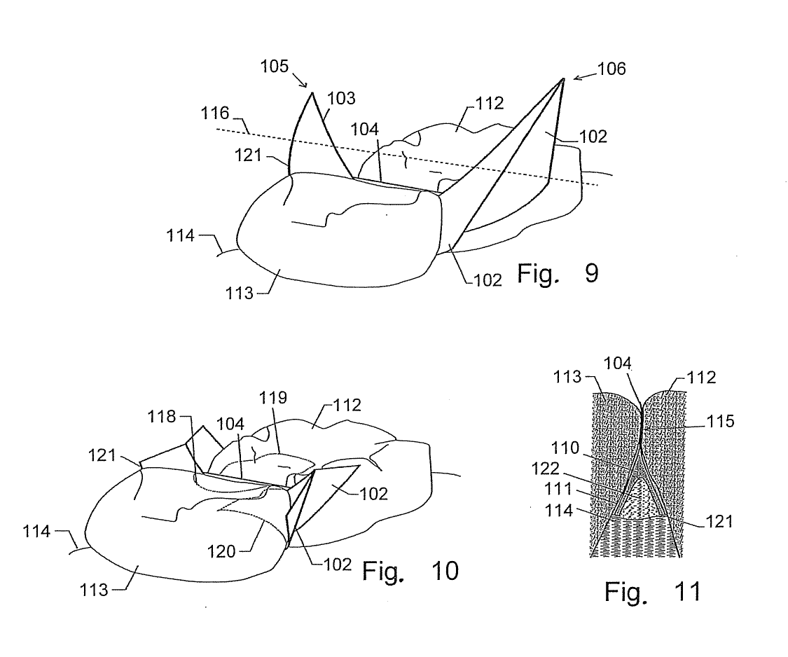

FIG. 10 shows the interdental wedge according to FIG. 9 after cutting off the tips.

FIG. 11 shows a vertical cross section of the interdental wedge according to FIG. 9 in the region of the contact point of the teeth.

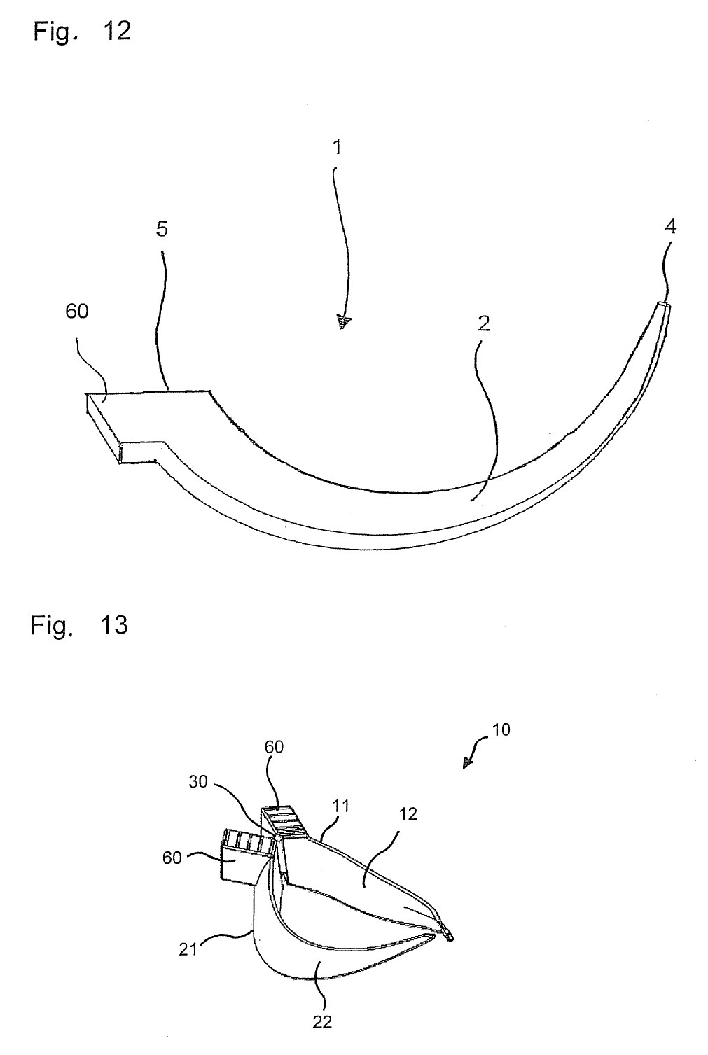

FIG. 12 shows an interdental wedge according to the invention as shown in FIG. 1, having an insertion aid.

FIG. 13 shows an interdental device according to the invention, having an insertion aid.

FIG. 1:

FIG. 1 illustrates a preferred interdental wedge (1) according to the invention. The interdental wedge is composed of the base body (2). The cross section of the base body (2) decreases along its length, so that one end (4) has the smallest cross section of the base body (2), and the other end (5) has the largest cross section of the base body. The base body is three-dimensionally curved along its length, i.e., the base body extension from one end (4) to the other end (5), so that the face which forms end (4) lies in a plane that is offset by an angle, which is not 0 degrees, with respect to the plane (in which the face is not visible in the figure) which forms the other end (5). The interdental wedge (1) may be inserted into an interdental region with its end having the smallest cross section (4) facing forward. This allows a matrix to be pressed against a tooth, a rubber dam to be fixed to the gum, and/or the contact points of the two teeth which form the interdental space to be pressed apart. The three-dimensional curvature of the base body (2) is selected so that the base body lies against a tooth, or against a matrix which follows the contour of a tooth, over a large region of the longitudinal axis.

FIG. 2:

FIG. 2 illustrates a preferred interdental device (10) according to the invention.

In FIG. 2a the interdental device (10) is illustrated in its original starting shape and starting position. The interdental device is composed of two interdental wedges (11, 21) which are formed from a base body (12, 22), respectively, and an intermediate piece (30) which connects the two base bodies (12, 22) to one another at their ends having the largest cross section (15, 25). Thus, the two base bodies (12, 22) and the intermediate piece (30) together form an essentially V-shaped device. The two base bodies (12, 22) each have an additional section (17, 27) which projects to the rear beyond the end (15, 25) that is connected to the intermediate piece (30). The two ends having the smallest cross section (14, 24) are located at a distance (36) from one another that is smaller than the distances between the base bodies (12, 22) at the midpoints of their lengths. In addition, the distance (36) is less than the width of a tooth. The two base bodies (12, 22) are each three-dimensionally curved. Thus, the faces which form the ends having the smallest cross section (14, 24) lie in two planes which are offset with respect to one another by an angle that is greater than 0 degrees. The one base body (12) is longer than the other base body (22). This simplifies use of the interdental device (10). The longer base body (12) may be inserted at its end (14) into an interdental space. The device may then be easily spread, wherein the contact of the base body (12) against a tooth simplifies the spreading due to the fact that the tooth forms a pressure point, which otherwise would have to be produced by a finger, for example. The other base body (22) may then be inserted into the other interdental space of the tooth. Both base bodies (12, 22) may then be further inserted as far as desired into the two interdental spaces. The base bodies have good contact with the tooth as a result of the three-dimensional curvatures of the base bodies (12, 22).

FIG. 2b illustrates the interdental device (10) from FIG. 2a in the spread shape and position. The two base bodies (12) and (22) are pressed apart due to the flexibility of the intermediate piece (30). The distance (36), as well as the angle (35) which is formed by the connection of the two base bodies (12, 22) and the intermediate piece (30), is increased by pressing the base bodies (12) and (22) apart. At the same time, pressing the two base bodies apart causes the additional sections (17) and (27) to move toward one another until, during spreading, they meet at a specified angle (35) and are pressed together. This prevents the two base bodies (12, 22) from being overspread beyond a specified angle (35).

FIG. 3:

FIG. 3 shows another view of the interdental device (10) from FIG. 2.

FIG. 3a shows the interdental device (10) in the starting shape and position as shown in FIG. 2a.

FIG. 3b shows the interdental device (10) in a shape and position as shown in FIG. 2b.

FIGS. 3a and 3b once again show the interdental wedges (11, 21) together with the base bodies (12, 22) and the intermediate piece (30). Also shown are the respective two ends (14, 15, 24, 25) of the base bodies (12, 22), and the projecting sections (17, 27).

FIG. 4:

FIG. 4 shows the use of a preferred interdental device (10) according to the invention for fixing a matrix (40) to a tooth (50).

The interdental device (10) has been inserted from the inside of the mouth facing outwardly, i.e., from the palatal or lingual side. The dental wedge (11) together with the base body (12) has been inserted into the interdental space (51) formed by the teeth (50) and (55). The dental wedge (21) together with the base body (22) has been inserted into the interdental space (52) formed by the teeth (50) and (56). The insertion has caused the two base bodies (12, 22) to spread apart, so that the two ends having the smallest cross section (14, 24) are farther apart than in the base position prior to the spreading. This is possible due to the elastic deformation of the intermediate piece (30) which connects the two ends having the largest cross section (15, 25). Overspreading is prevented by the projecting sections (17, 27) due to the fact that these meet one another before overspreading occurs. As a result of the three-dimensional curvatures of the base bodies (12, 22), the base bodies (12, 22) contact a large region of the length along the tooth (50), i.e., at a partial matrix (40), which follows the contour of the tooth (50). On account of the curvatures, the two base bodies (12, 22) approximately enclose the tooth (50). The curvatures of the base bodies (12, 22) also reduce the risk of injury when the interdental device (10) is inserted, since the ends (14, 24) are bent away from the jaw region. The spreading of the two base bodies (12, 22) causes tension to develop in the interdental device. As a result of this tension, the partial matrix (40) is pressed by the base body (12) against the tooth (50) in the region of a cavity (54) which merges into the interdental space (51). Of course, a ring matrix could also be pressed on. If necessary, a second partial matrix could also be pressed by the base body (22) against the tooth (50) in the region of the interdental space (52). The matrix is firmly and tightly pressed by the base body (12) in such a way that filling of the cavity (54) is possible without overflow, and in particular, no filling material is able to penetrate into the cervical region of the interdental space (51). The base bodies also press teeth (55) and (56) slightly away from tooth (50), so that the theoretical contact point (58) between teeth (50) and (55) as well as the contact point (59) between teeth (50) and (56) are reversibly separated. Due to the insertion from the rear, the regions of the base bodies (12, 22) which have a larger cross section are situated in the back region of the interdental spaces, which likewise has a larger cross section, and the regions of the base bodies (12, 22) which have a smaller cross section are situated in the front region of the interdental spaces, which likewise has a smaller cross section.

FIGS. 5 through 8:

One preferred alternative embodiment of the invention is illustrated in FIGS. 5 through 8. This embodiment is composed of a single part, and includes a base body 101 that is formed by two leg plates 102 which merge into one another in the region of a bent edge 103. A flexible separating film 104 is situated in a middle region of the edge. The edge 103 follows an essentially U-shaped or V-shaped curve which is approximately parabolic. The edge has the greatest curvature in the middle, and the end regions of the edge extend in opposite directions. The curvature of the edge 103 is concave; i.e., the base body 101 forms a type of indentation 109 in which the contact point of the teeth comes to rest, as described in greater detail below. The radius of curvature r of the edge 103 in the region of the separating film 104 is 0.5 to 3 mm, in particular 1 to 2 mm. This corresponds to a typical radius of the contact point or contact region of two adjacent teeth. The separating film 104 is stretched at the region of greatest bending of the edge 103. On one side the separating film follows the curve of the edge 103, and on the other side has a straight or concave outer edge 108. The separating film has the smallest possible thickness, preferably in the range of 100 μm or less, so that it causes minimum spreading of the teeth during use, as described in greater detail below. The leg plates 102 are approximately triangular in shape, with two long sides and one short side. They converge to a point at a first end 105 of the device, and widen toward the second end 106, as is apparent in particular from FIG. 8. The leg plates meet at their respective long sides in the region of the edge 103. As is apparent from FIGS. 1 and 2, the side edges 121 of the leg plates 102 are bent. An interspace 107 which widens as it extends away from the edge 103 is formed between the leg plates 102 (FIG. 7). In the undeformed state, the angle α between the leg plates 102 is preferably at least 90°, so that the leg plates satisfactorily press against the teeth. In addition, the leg plates, viewed in cross section perpendicular to the edge 103, are increasingly bent upwardly, i.e., toward points 105, 106, as is apparent from FIG. 8, so that the angle between the leg plates becomes increasingly larger toward the side edges 121. The leg plates 102 may be pressed together under elastic deformation, resulting in a corresponding decrease in the angle α and the interspace 107. As will become apparent from the following discussion, as a result of this shaping and elasticity it may be ensured that the leg plates 102 conform exactly to the convex outer sides of the teeth. As is apparent from FIG. 7, the device has a core body 110 and a coating 111. The core body 110 is made of hard plastic, for example, while the coating 111 is made of a softer material. The coating 111 is as smooth as possible and covers the outer sides of the leg plates 102, at least in the middle region of the device. The coating is thinner toward the separating film 104, thus forming an essentially continuous transition. Steps in the outer side of the filling to be produced are avoided in this manner.

FIGS. 9 through 11:

With reference to FIGS. 9 through 11, the following description concerns the manner in which the interdental wedge from FIGS. 5 through 8 is inserted between two teeth 112 and 113. The interdental wedge is inserted by gripping it at the second end 106, preferably, for example, by pushing the index finger between the leg plates 102 and pressing against the leg plates 102 from the outside, using the thumb and middle finger. With the pointed end 105 in front, the device is then inserted, preferably from the lingual side, into the interspace between the teeth 112, 113, specifically, in such a way that the tip 105 passes between the contact point 115 of the teeth and the gum 114. The leg plates are pressed together in the region between the teeth, as illustrated in particular in FIG. 11. To allow satisfactory manual manipulation of the interdental wedge according to the invention, the length of the edge 103 is preferably at least 3 cm. The interdental wedge is inserted with twisting, so that the separating film 104 enters between the teeth, from bottom to top, into the region of the contact point 115. The end position is reached when the separating film 104 covers the entire contact point 115, and the bottom ends of the leg plates 102 contact the gum 114 between the teeth. If the expansion between the edge 105 and the side edges 121 of the leg plates 102 is too large, one or both side edges 121 may be cut back using scissors or a tool. In addition, various interdental wedges having different shapes and sizes are preferably provided. When the interdental wedge is correctly positioned, at least the pointed end 105, preferably both ends 105 and 106, is/are cut off approximately at the height of the dental crowns, as indicated by line 116 in FIG. 9. This simplifies folding up the leg plates 102 at the buccal or lingual side of the teeth. The completely installed device is illustrated in FIG. 10. It is apparent that the leg plates 102 conform to the teeth 112, 113 due to the spreading force produced by the core 110 on the buccal and lingual sides. Good contact is also ensured between the interdental wedge and the tooth surfaces in the dental interspace, as illustrated in FIG. 11, wherein uneven areas of the tooth surfaces are also evened out due to the softness of the coating 111. Since the side edges 121 of the leg plates 102 are bent, they reach their lowest point beneath the contact region 115, so that they follow the corresponding concave shape of the papillae at the interdental col without injuring the papillae. The fillings may now be produced. As indicated by dashed lines 118, 119, this may be a filling in the anterior or posterior tooth, or may be two simultaneous fillings. When two fillings are produced, the anterior tooth 113 is preferably filled first so that the separating film 104 is pushed back in the region of the contact point 115. An anatomically correct convex shaping of the anterior tooth in the contact point 115 is thus ensured. By use of the interdental wedge according to the invention, the surface of the filling may acquire an anatomically correct shape, at least in the region between the teeth, and does not require subsequent processing. Any excess filling material collects in occlusal, buccal, or lingual regions, where it may be easily ground off. To ensure even better shaping in the buccal or lingual region, a peelable film 120 may be provided on the surface of the leg plates 102. As illustrated by dashed lines in FIG. 10, this film may be detached in the end regions of the leg plates and adhered to the buccal or lingual side face of the tooth. To achieve greater stability of the leg plates 102 between the teeth, after the device is inserted a curing bonding compound 122 may be introduced into the interspace 107, as illustrated in FIG. 11.

It follows from the above description that the illustrated interdental wedge may be easily inserted into the interspace between the teeth in a completely atraumatic manner. This process is facilitated by the bent shape and the pointed end 105. Due to the overflow length at the end 106, the interdental wedge may be easily inserted by hand. In the inserted position, the interdental wedge is held stable on the lingual and buccal sides of the teeth by the spread leg plates 102. As mentioned, the interdental wedge may be provided in different shapes and sizes so that it may also be inserted between anterior teeth, for example. Since the base body 101 is wider at the end 106 and has a broader taper than at end 105, it has a good fit with the dental interspace when it is inserted from the lingual side due to the fact that the contact point 115 is closer to the buccal side than to the lingual side of the teeth.

The interdental wedge is best suited for microisolation of the dental interspace. It delimits the filling space and provides isolation from sulcus fluid, blood, and saliva, while still allowing good access from the occlusal side. The interdental wedge may be used in endodontics for proximal sealing of profoundly damaged teeth. When the interdental wedge is used for insertion of ceramic inlays, partial crowns, etc., the separating film 104 may also be completely or partially removed if it causes interference.

FIG. 12:

FIG. 12 shows an interdental wedge (1) according to FIG. 1, having an insertion aid (60). This insertion aid simplifies the application of the interdental wedge in an interdental space. In particular, a translational motion and/or a rotational motion of the interdental wedge is/are facilitated for insertion into the interdental space.

FIG. 13:

FIG. 13 shows an interdental device (10) which has two insertion aids (60). The interdental device (10) is composed of two interdental wedges (11, 21), each of which is formed from a base body (12, 22), respectively, and an intermediate piece (30) which joins the two base bodies (12, 22) together. Thus, the two base bodies (12, 22) and the intermediate piece (30) together form an essentially V-shaped or U-shaped device. The two base bodies (12, 22) each have an additional section (60) which is connected to the intermediate piece (30) at the back via the end of the base bodies (12, 22). The additional sections (60) are used as insertion aids (60), and facilitate application of the interdental device (10) in the interdental spaces. At the same time, the sections (60) are used to press the base bodies (12, 22) apart. Reference is made to FIG. 2 for the remaining features of the interdental device (10).

1-23. (canceled)

24. An interdental wedge comprising a base body, wherein a cross section of the base body decreases, at least in places, along a length of the base body, the base body being three-dimensionally curved, at least in places.

25. The interdental wedge according to claim 24, wherein the base body has a triangular cross section.

26. The interdental wedge according to claim 24, wherein a smallest cross section of the base body is located at a first end of the base body, and a largest cross section of the base body is located at a second end of the base body.

27. The interdental wedge according to claim 26, wherein the smallest cross section of the base body is designed as a point or edge, or as a flattened point or flattened edge, or as a surface.

28. The interdental wedge according to claim 24, wherein the interdental wedge is made of plastic.

29. The interdental device having two interdental wedges according to claim 24, wherein the two base bodies of the interdental wedges are connected to one another at each of their respective ends.

30. The interdental device according to claim 29, wherein the two base bodies are connected to one another at the second end having the largest cross section.

31. The interdental device according to claim 29, wherein the two base bodies of the interdental wedges are connected to one another in an elastically deformable manner.

32. The interdental device according to claim 29, wherein the two base bodies of the interdental wedges are connected to one another via an intermediate piece.

33. The interdental device according to claim 32, wherein the intermediate piece is elastically deformable.

34. The interdental device according to claim 29, wherein the two base bodies of the interdental wedges are situated as legs, wherein the distance between the legs increases over one section and decreases over another section.

35. The Interdental device according to claim 29, wherein the base bodies of the interdental wedges are connected to one another in such a way that the base bodies may be spread by elastically deforming the base bodies and/or the intermediate piece.

36. The interdental device according to claim 35, wherein tension is developed between the base bodies by spreading the base bodies of the interdental wedges.

37. The interdental device according to claim 35, wherein each of the two legs has an additional section which, in the longitudinal axis of the legs, extends beyond the connecting section of the legs, so that spreading the legs causes the two additional sections to approach one another.

38. The interdental device according to claim 29, wherein the interdental device may be divided into two parts at the intermediate piece or the connecting point of the two base bodies by cutting or tearing.

39. The interdental device according to claim 29, wherein the interdental device is designed as one piece.

40. A method of using an interdental wedge according to claim 24, the method including implanting the interdental wedge in a patient.

41. The method according to claim 40, wherein implanting the interdental wedge includes fixing a matrix in an interdental region.

42. The method according to claim 40, wherein implanting the interdental wedge includes fixing a rubber dam in the interdental region.

43. The method according to claim 40, wherein implanting the interdental wedge includes pressing apart two adjacent teeth in a contact point region.

44. A kit containing at least one interdental wedge in accordance with claim 24, the kit further comprising operating instructions.

45. The kit according to claim 44, wherein the interdental wedge is sterilely packaged.

46. The kit according to claim 44, further comprising at least one matrix, in particular at least one partial matrix, and/or a rubber dam.

47. A method for fixing at least one matrix to a tooth, in particular in a proximal region or in two proximal regions of the tooth, the method comprising:
placing the at least one matrix on the tooth, in a region of a cavity;
inserting the two interdental wedge base bodies of an interdental device according to claim 29, wherein the first interdental wedge base body is inserted into the distally adjacent interdental region of the tooth, and the second interdental wedge base body is inserted into the mesially adjacent interdental region of the tooth, so that the at least one matrix is clamped between the tooth and at least one of the interdental wedge base bodies.
